(19) United States
(12) Patent Application Publication
(10) Pub. No.: US 2026/0022587 A1
(43) Pub. Date: Jan. 22, 2026

(54) Identifier of the State of a Lock

(71) Applicant: OJMAR, S.A., Elgoibar (ES)

(72) Inventors: Jon Zabala Zabaleta, Elgoibar (ES); Jokin Aguirrezabala Olasagasti, Elgoibar (ES)

(21) Appl. No.: 18/841,055

(22) PCT Filed: Feb. 10, 2023
(86) PCT No.: PCT/ES2023/070069

§ 371 Date: Aug. 23, 2024

(30) Foreign Application Priority Data
Feb. 25, 2022 (ES) U202230322

(51) Int. Cl. E05B 41/00; E05B 63/00

(52) U.S. Cl. CPC E05B 41/00; E05B 63/0017

(57) ABSTRACT

Disclosed is an identifier of the state of a lock, the lock including a locking tab designed to move between a distal position and a proximal position to close/open the lock. The identifier includes a slider attached to the tab and provided with a surface having two colours, on which surface is provided a viewer cover with a window, through which one of the colours is displayed according to the position of the locking tab, thereby indicating the closed/open state of the lock.

### CROSS-REFERENCE TO RELATED APPLICATIONS

This application is the United States national phase of International Patent Application No. PCT/ES2023/070069 filed Feb. 10, 2023, and claims priority to Spanish Patent Application No. U202230322 filed Feb. 25, 2022, the disclosures of which are hereby incorporated by reference in their entireties.

### BACKGROUND OF THE INVENTION

### Field of the Invention

The present invention relates to an identifier of the state of a lock, the configuration and design of which makes it easier for the user to know whether the lock is open or closed.

The invention is applicable to any type of lock in which there is a need to know whether it is closed or open, more particularly applicable to all types of locks used today in electronic or mechanical lockers, for both right-hand and left-hand locks, as well as for locks that are positioned like a drawer.

### Description of Related Art

In facilities where there are lockers for storing objects, it is necessary for users to be able to know the state of said lockers, i.e., whether they are open or closed, in order to be able to use one that is open, but it is often difficult to know visually the state of said lockers because the users do not know whether or not they are free until they are near the lockers. Sometimes, the users even have to try to open the locker door to find out its state.

There are systems on the market, such as electronic locks, in which the state of the door is indicated by a red or green light, which requires the use of mains power supply or batteries, which complicates and increases the price of the product, and furthermore in most cases, when the user is at a certain distance from the lock and/or at a certain viewing angle, the user does not perceive either the colour or the light emitted by the lock.

The invention solves the preceding problems of the state of the art by providing an identifier which shows the state of the lock, such that it allows the user to be able to view whether the lock is open or closed from a distance.

### SUMMARY OF THE INVENTION

In order to achieve the objectives and solve the problems discussed above, the invention consists of an identifier of the state of a lock, which is applicable to those locks comprising a locking tab that has been designed to move between two positions, i.e., a proximal position in which the lock is open and a distal position in which the lock is closed.

The main novelty of the invention lies in the fact that the identifier is provided with a slider which is fixed to the tab and provided with a surface having two different colours.

Furthermore, it comprises a viewer cover arranged on the slider and including a window, such that the movement of the tab, and therefore of the slider, causes one of the two colours on the surface of the slider to be displayed through said window of the cover of the viewer, such that one of the colours is displayed when the lock is open and the other colour is displayed when the lock is closed, each of the colours corresponding with the state of the lock, i.e., open or closed.

In the preferred embodiment of the invention, the colours on the surface of the slider are red and green, such that green is displayed through the window of the viewer cover when the lock is open and red is displayed when the lock is closed.

In one embodiment, it is envisaged for the slider to be arranged on a support, to which the viewer cover is attached, such that the slider is arranged between the support and the viewer cover with possibility of movement.

To make the movement of the slider on the support easier, it has been envisaged that the identifier comprises a guide for guiding the movement of the slider which, in the exemplary embodiment, is determined by a female guide provided in the slider and a male guide arranged on the support.

In the preferred embodiment, the slider is fixed to the tab by means of a drive shaft running through an elongated hole provided in the support to enable the movement of the slider when the tab moves every time the lock is opened or closed.

### BRIEF DESCRIPTION OF THE DRAWINGS

The terms FIG., FIGS., Figure, and Figures are used interchangeably to refer to the corresponding figures in the drawings.

To complete the description, and for the purpose of helping to make the features of the invention more readily understandable, this description is accompanied by a set of figures constituting an integral part of the same, which by way of illustration and not limitation represents the following:

FIG. 1 shows an exploded view of an embodiment of the identifier of the invention.

FIG. 2 shows a perspective view of the slider of the identifier of the preceding figure fixed to a locking tab of those used in locks for lockers.

FIG. 3 shows a plan view of the slider mounted on the support and without the viewer cover.

FIG. 4 shows a plan view of the identifier in the position in which the lock is open, a position in which the locking tab is in the proximal position.

FIG. 5 shows a plan view of the identifier in the position in which the lock is closed, a position in which the locking tab is in the distal position.

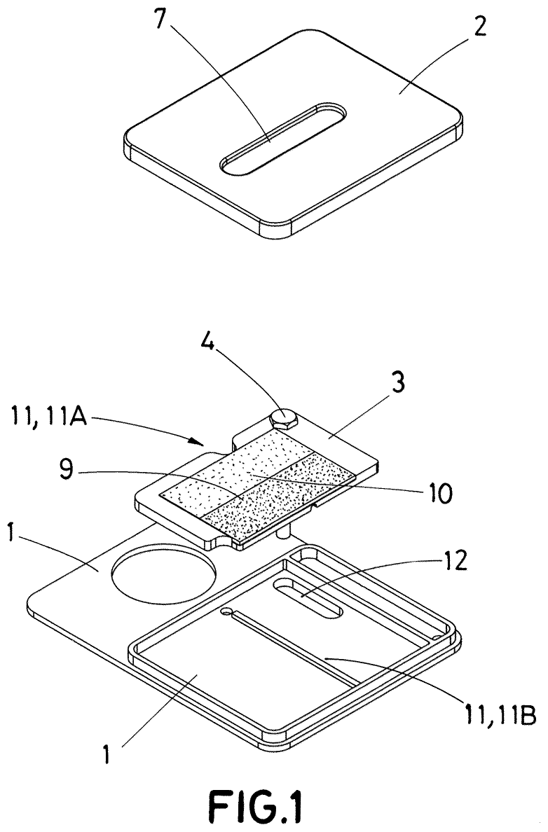

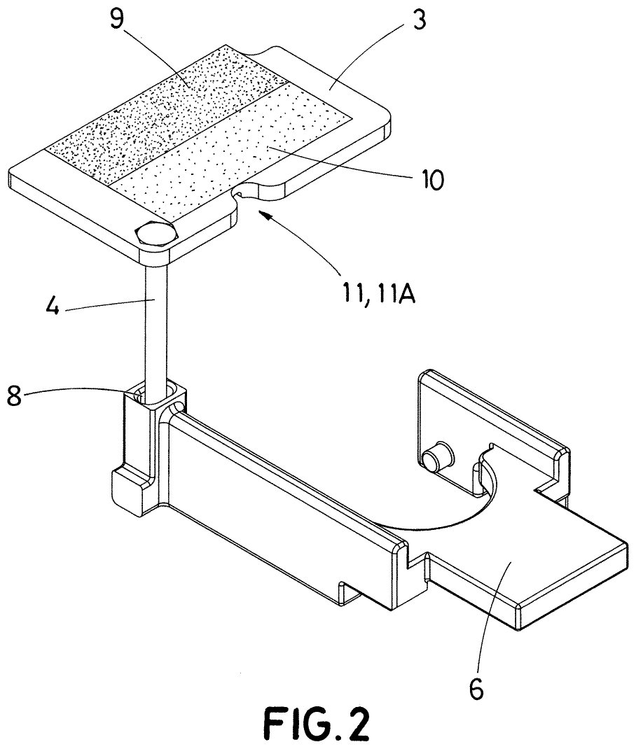

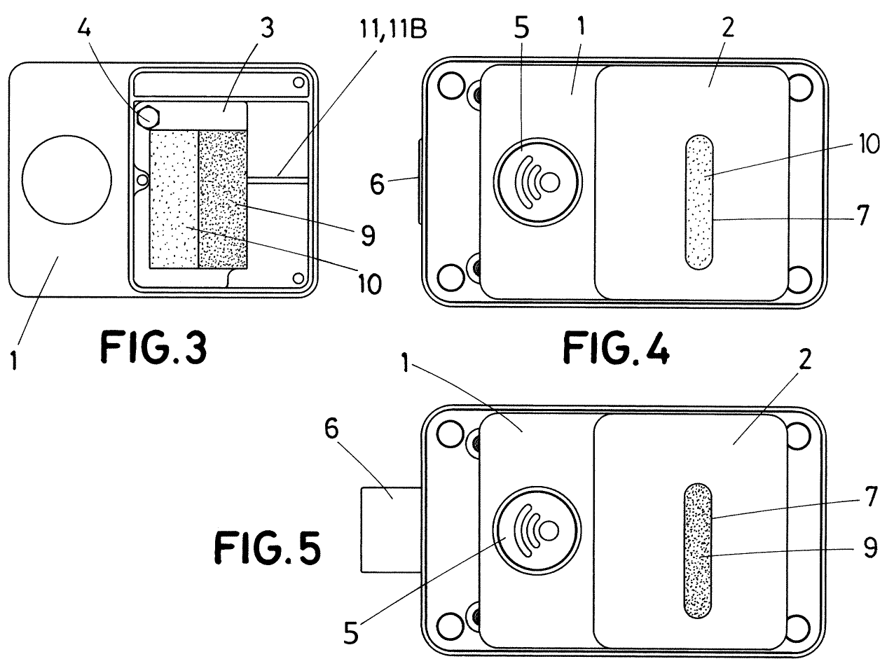

### DESCRIPTION OF THE INVENTION

The invention is described below based on the aforementioned figures in which the identifier comprises the following elements:
1—Support
2—Viewer cover
3—Slider
4—Drive shaft
5—Push-button
6—Locking tab
7—Window
8—Hole
9—Red colour
10—Green colour
11—Guide
11A—Female profile
11B—Male profile
12—Elongated hole

The identifier of the invention applies to those locks for lockers which are provided with a locking tab (6), movable between a distal position in which the lock is closed and a proximal position in which the lock is open.

The identifier is installed on the outside of the locker door and has a colour code that allows knowing whether the lock is closed or open.

To that end, it comprises a support (1) on which there is arranged a slider (3) which is provided with a surface including two colours (9, 10) and which comprises thereon a viewer cover (2) provided with a window (7) through which one of said colours is displayed. This viewer cover (2) is attached to the support (1), such that the slider (3) is arranged between the support (1) and the viewer cover (2), with possibility of movement.

The slider (3) is fixed to the locking tab (6) by means of a drive shaft (4) running through an elongated hole (12) of the support (1) and inserted into a hole (8) provided in the locking tab (6), such that when the lock is closed, the tab (6) moves to its distal position, driving the slider (3) during the movement thereof, as a result of the drive shaft (4), such that one of the colours on the surface of the slider (3) is located in correspondence with the window (7) which, in the example, is red colour (9) indicating that the lock is closed.

When the lock is open, the locking tab (6) moves to its proximal position, moving the slider (3) such that the other colour on the surface of the slider (3) is displayed through the window (7) which, in the example, is green colour (10), indicating that the lock is open.

To make the movement of the slider (3) easier, a guide (11) made up of a female profile (11A) provided in the slider (3) in which a male profile (11B) arranged on the support (1) slides has been envisaged.

As a result of the configuration and design of the identifier, it can be mounted both on mechatronic locks, in which the user performs a mechanical action to open or close the door such as, for example, by means of a push-button (5), and also in automatic locks, in which the user brings a coded device closer and it is the lock itself that opens or closes automatically. Likewise, it can also be used on purely mechanical locks.

1. An identifier of the state of a lock, the lock comprising a locking tab designed to move between a distal position and a proximal position to close/open the lock; the identifier comprising
a slider which is attached to the tab and provided with a surface having two colours, and
a viewer cover provided on the slider and having a window, through which one of the colours is displayed according to the position of the locking tab, thereby indicating the closed/open state of the lock.

2. The identifier of claim 1, wherein the slider is arranged on a support, in which the viewer cover is attached.

3. The identifier of claim 2, comprising a guide for guiding the movement of the slider.

4. The identifier of claim 1, wherein the slider is fixed to the tab by means of a drive shaft.

5. The identifier of claim 4, wherein the slider is arranged on a support, in which the viewer cover is attached, and wherein the drive shaft runs through an elongated hole provided in the support.

6. The identifier of claim 1, wherein the colours on the surface of the slider are red to indicate that the lock is closed and green to indicate that it is open.
